(19) United States
(12) Patent Application Publication
(10) Pub. No.: US 2021/0228452 A1
(43) Pub. Date: Jul. 29, 2021

(54) Pacifier Mitten

(71) Applicant: Addison Harper LLC, Ridgefield, CT (US)

(72) Inventor: Nicholas Aiken, Ridgefield, CT (US)

(21) Appl. No.: 16/776,254

(22) Filed: Jan. 29, 2020

(51) Int. Cl. A61J 17/00; A41D 19/01

(52) U.S. Cl. CPC A61J 17/001; A41D 11/00; A41D 19/01; A61J 17/1011

(57) ABSTRACT

The present disclosure is directed to a pacifier, a teether, stuffed animal, and/or rattle attachable/detachable from a no-scratch baby mitten/glove/hand covering. The pacifier, teether, stuffed animal, and/or rattle can either be fixed or detachable from the mitten/hand covering.

### BACKGROUND OF THE DISCLOSURE

### Field of the Invention

This disclosure is directed to hand coverings and accessories and, more specifically, mittens, gloves, socks or other hand coverings for babies to prevent scratching and to provide soothing via a pacifier, teether or toy.

### Description of the Related Art

No scratch baby mittens/hand coverings are placed on an infant's hand to prevent an infant from scratching their sensitive skin with their fingernails. Pacifiers for babies are also known and used by infants as well. Conventionally, baby pacifiers and no-scratch baby mittens have been separate products. Pacifiers in the past may come with, at most, a clip or a holder, but babies are unable to grab the pacifier themselves, even if it is attached to a clip or holder. A pacifier, alone, or with a clip or holder, however, cannot be used by a baby that is wearing no scratch mittens. Hence, the present disclosure addresses this problem by providing a mitten with an integrated pacifier.

### SUMMARY OF THE INVENTION

The present disclosure is directed to a pacifier, a teether, stuffed animal, and/or rattle attachable/detachable from a no-scratch baby mitten/glove/hand covering. The pacifier, teether, stuffed animal, and/or rattle can either be fixed or detachable from the mitten/hand covering.

Other features and aspects will be apparent from the following detailed description, the drawings, and the claims.

### BRIEF DESCRIPTION OF THE DRAWINGS

FIG. 1A shows one embodiment of the present disclosure.

FIG. 1B shows an embodiment of the present disclosure being used by a baby.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure is directed to a pacifier, a teether, stuffed animal, and/or rattle attachable/detachable from a no-scratch baby mitten/glove/hand covering. The pacifier, teether, stuffed animal, and/or rattle can either be fixed or detachable from the mitten.

This invention solves multiple problems including: baby can self-soothe by putting the pacifier in their own mouth, babies will not get germs from the pacifier falling on the ground, no-scratch mittens protect baby's hands from germs and protects their face from scratching, and helps parents by not having to constantly put the pacifier back in the baby's mouth when they drop or lose it.

In embodiments, the pacifier with the hand covering can be changed to other items such as a teether for when a baby's teeth start coming in, a stuffed animal, or a rattle. The hand covering may have these items attached and/or they may be detachable.

The hand cover/mitten may be made from any material known and used in the art for making baby gloves or hand mittens. Likewise, the pacifier, teether, stuffed animal, and/or rattle may also be made of any materials known in the art for making such items.

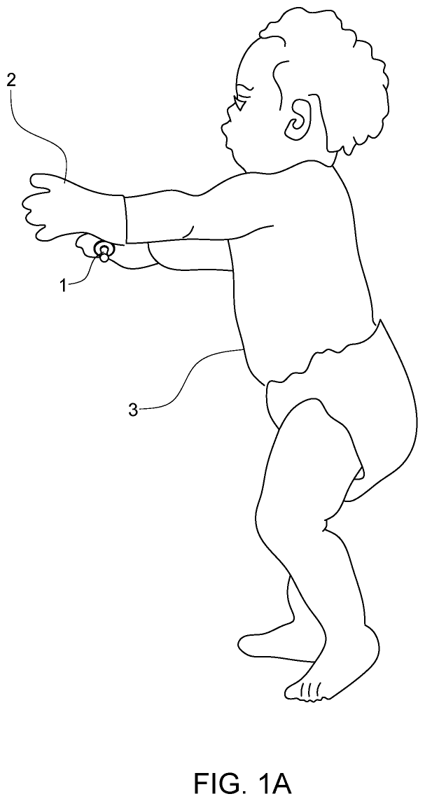

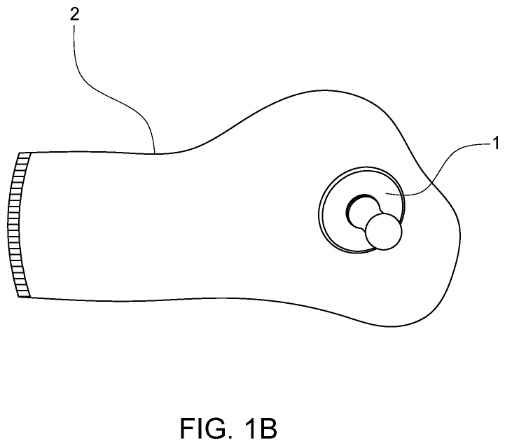

FIG. 1A shows one embodiment of the present disclosure. In FIG. 1A, a hand covering 2 has an attachable/detachable pacifier/nipple 1.

FIG. 1B shows an embodiment of the present disclosure being used by a baby 3. In FIG. 1B, hand covering or mitten 2 is shown on a baby's hand and a detachable pacifier/nipple 1 is in the baby's mouth.

While this disclosure includes specific examples, it will be apparent after an understanding of the disclosure of this application has been attained that various changes in form and details may be made in these examples without departing from the spirit and scope of the claims and their equivalents.

What is claimed is:

1. A hand covering for a baby comprising:
an attachable/detachable item including a pacifier, a teether, a stuffed animal, and/or a rattle.

2. The hand covering of claim 1, wherein the item is a pacifier.

3. The hand covering of claim 1, wherein the item is a stuffed animal.

4. The hand covering of claim 1, wherein the item is a rattle.

5. The hand covering of claim 1, wherein the hand covering is a mitten.
